(19) United States
(12) Patent Application Publication
(10) Pub. No.: US 2017/0238763 A1
(43) Pub. Date: Aug. 24, 2017

(54) Automatic Lifting Device for Toaster Carrier

(71) Applicant: Kinwin Electric Industrial Co., Ltd., Jiangmen City (CN)

(72) Inventor: Sam Mao, Jiangmen City (CN)

(21) Appl. No.: 15/278,050

(22) Filed: Sep. 28, 2016

(30) Foreign Application Priority Data
Feb. 24, 2016 (CN) 201620139549.3

(51) Int. Cl. A47J 37/08

(52) U.S. Cl. CPC A47J 37/0821

(57) ABSTRACT

The utility model discloses an automatic lifting device for a toaster carrier, comprising a machine base, carriers, sliding guide pillars, a slide seat, a rocker arm, a motor and a motor mounting base. The motor is fixed on the motor mounting base, and an output rotation shaft of the motor is connected with the slide seat via the rocker arm. The motor mounting base is provided with an upper trigger switch and a lower trigger switch corresponding to swinging positions of the cam. The motor drives the rocker arm to rotate so as to drive the slide seat to rise and fall, thus the automatic control of the rising and falling of the carriers is achieved.

### TECHNICAL FIELD

The utility model relates to the technical field of toasters, in particular to an automatic lifting device for a toaster carrier.

### BACKGROUND ART

The toaster is an electrically heated cooker which is mainly used for toasting a sliced bread, and by which not only can toast the sliced bread into light brown, but also improve its flavor and taste to whet the appetite. A toaster with a function of automatically lifting the bread is commercially available with the following working process: placing a bread in a bread slot of the toaster; controlling and lowering a carrier to the bottom of the bread slot, at this point a switch is triggered to turn on the power and a heating wire starts to work for heating and roasting; after a set time of the roasting is reached, the heating wire is switched off; and a motor drives the carrier to rise up to lift the bread, and the roasting is completed. In a structure of such toasters, generally an upper limit switch and a lower limit switch are arranged. When the carrier is raised up to a top position or lowered to a bottom position, a corresponding switch is triggered to stop the motor. However, this control manner that realized by rising up and lowering a carrier to trigger the limit switches is less accurate, which may make the bread not to be lifted to the desired height and may affect the usage.

### SUMMARY OF THE UTILITY MODEL

In order to solve the abovementioned technical problems, the utility model provides an automatic lifting device for a toaster carrier, which may effectively improve the positioning accuracy in rising up and lowering the carrier, and the structure thereof is more useful and reliable.

In order to achieve the above object, the technical solution adopted by the utility model is as follows:

An automatic lifting device for a toaster carrier, comprises a machine base, carriers, sliding guide pillars, a slide seat, a rocker arm, a motor and a motor mounting base, wherein the sliding guide pillars are perpendicularly fixed on the machine base, the slide seat is slidably connected to the sliding guide pillars, the carriers are connected to the slide seat, the motor is fixed on the motor mounting base, and the output rotation shaft of the motor is connected with the slide seat via the rocker arm; wherein a cam is arranged on the rocker arm, the motor mounting base is provided with an upper trigger switch and a lower trigger switch corresponding to swinging positions of the cam, and both the upper trigger switch and the lower trigger switch are shrapnel-type trigger switches.

In an improvement of above technical solution, a guide slot is arranged on the slide seat, and a bearing is arranged in the guide slot and connected with the rocker arm by a shaft.

Preferably, the guide slot is an arc-shaped slot.

Preferably, the cam and the rocker arm are coaxially connected with the output rotation shaft of the motor, and the cam is arranged on one side of the output shaft of the motor close to the motor.

Preferably, the rocker arm and the cam are an integrally-formed L-shaped crank structure.

In one embodiment, the upper trigger switch and the lower trigger switch are provided on the left and right side of the rocker arm, respectively, and arranged corresponding to each other, and when the rocker arm swings in linkage with the cam, one end of the cam away from the output shaft triggers the upper trigger switch and the lower trigger switch.

Preferably, limiting posts for limiting the positions of shrapnels are arranged on the motor mounting base respectively corresponding to the upper trigger switch and the lower trigger switch.

In another embodiment, the upper trigger switch and the lower trigger switch are respectively provided on the left and right side of the rocker arm, and when the rocker arm swings in linkage with the cam, the side edge of the cam triggers the upper trigger switch and the lower trigger switch.

The utility model has the advantages that the automatic lifting device provided by the utility model is applicable to the toaster carrier, and the motor drives the rocker arm to rotate so as to drive the slide seat to rise and fall, thereby realizing the automatic control of the rising and falling of the carrier. When in operation, the bread carrier falls down to a set position under the driving of the motor, and the lower trigger switch is triggered by the cam on the rocker arm to stop the motor from running at this moment, and a heating wire in the toaster is powered on for heating; after the bread is roasted for a preset time, the bread carrier automatically rises up to the original height thereof, the heating wire is controlled to stop working, and the upper trigger switch is triggered by the cam to stop the motor from running at this moment. The degree of automation is high, the structure is useful and reliable, the operation is convenient, the control manner is easier to implement, and the production cost is lower.

### BRIEF DESCRIPTION OF THE DRAWINGS

Hereinafter, specific embodiments of the utility model will be further described with reference to the accompanying drawings, in which:

FIG. 1 is a schematic front perspective view of a structure of a first embodiment of the utility mode;

FIG. 2 is a schematic back perspective view of the structure of the first embodiment of the utility mode;

FIG. 3 is a schematic structural back view of the first embodiment of the utility mode;

FIG. 4 is a schematic exploded view of the structure of the first embodiment of the utility mode;

FIG. 5 is a schematic perspective view of a structure of a second embodiment of the utility mode; and

FIG. 6 is a schematic view of the assembly structure of the first embodiment of the utility mode.

### DETAILED DESCRIPTION OF THE UTILITY MODEL

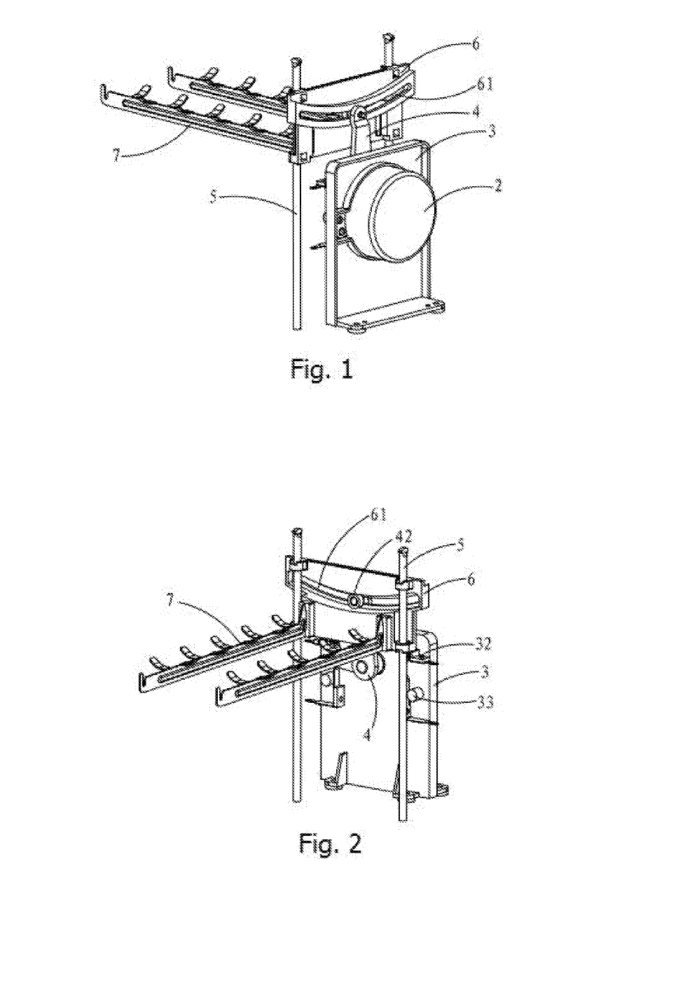

Referring to FIGS. 1 and 2, an automatic lifting device for a toaster carrier provided by the utility model comprises a machine base 1, carriers 7, sliding guide pillars 5, a slide seat 6, a rocker arm 4, a motor 2 and a motor mounting base 3, wherein the machine base 1 is the base of the housing of the roaster, the sliding guide pillars 5 are perpendicularly fixed on the machine base 1, the slide seat 6 is slidably connected to the sliding guide pillars 5, the carrier 7 is connected to the slide seat 6 and placed in a bread slot 8 of the toaster, two carriers 7 are arranged on the slide seat 6, the motor 2 is fixed on the motor mounting base 3, an output rotation shaft of the motor 2 is connected with a rocker arm 4 after passing through the motor mounting base 3, and the other end of the rocker arm 4 is connected with the slide seat 6, thus when the motor 2 runs, the slide seat 6 is driven via the rocker arm 4 to move along the sliding guide pillars 5, and thereby achieving the automatic control of rising and falling of the carriers 7.

Wherein a cam 41 is arranged on the rocker arm 4, an upper trigger switch 31 and a lower trigger switch 32 are arranged on the motor mounting base 3 corresponding to swinging positions of the cam 41, and both the upper trigger switch 31 and lower trigger switch 32 are shrapnel-type trigger switches. The particular principle is that the rocker arm 4 and the cam 41 rotate synchronously, and when the cam 41 rotates to the position of the upper trigger switch 31 or the position of the lower trigger switch 32, the cam 41 touches the metal shrapnel, thus the upper trigger switch 31 or the lower trigger switch 32 is closed to trigger and control the motor 2 to stop running The control sensitivity of the shrapnel-type trigger switches is higher, and the installation is more flexible and convenient.

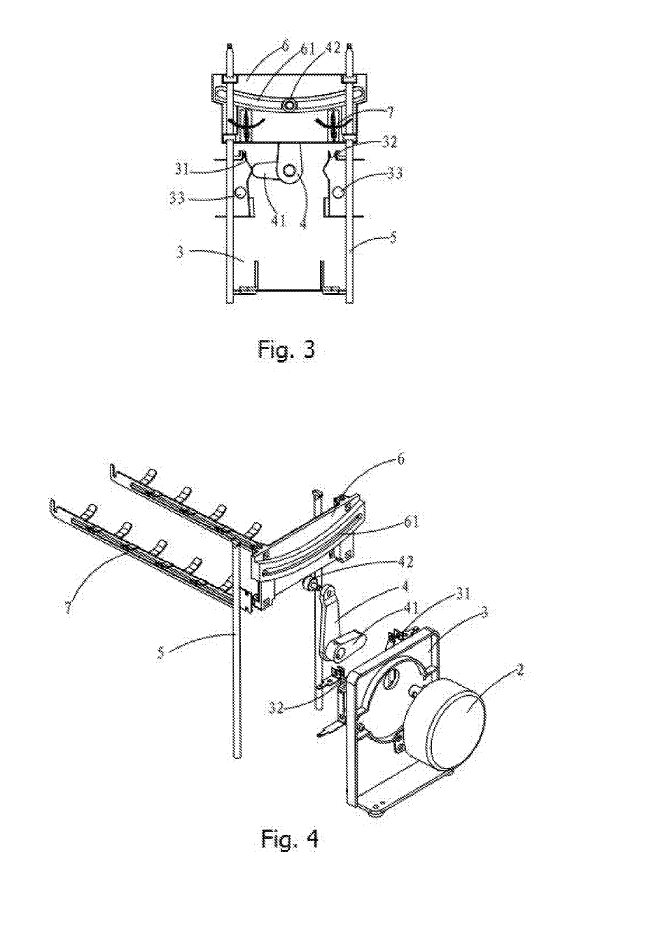

Referring to FIGS. 3 and 4, a guide slot 61 is arranged on the slide seat 6, a bearing 42 is arranged in the guide slot 61 and connected with the rocker arm 4 by a shaft, and the bearing 42 may slide along the guide slot 61. This structure reduces friction between the rocker arm 4 and the slide seat 6 such that the rocker arm 4 drives the slide seat 6 to slide more smoothly. Since the swinging path of the rocker arm 4 is arc-shaped, the guide slot 61 is provided to be an arc-shaped slot, which helps the joint movement of the slide seat 6 with the rocker arm 4.

For the further optimized structure, the cam 41 and the rocker arm 4 are coaxially connected with the output rotation shaft of the motor 2, and the cam 41 is arranged on one side of the output shaft of the motor 2 close to the motor 2, namely, the cam 41 and the rocker arm 4 are not provided in the same plane, thus the interference between the cam 41 and the slide seat 6 is avoided. Preferably, the rocker arm 4 and the cam 41 are an integrally-formed L-shaped crank structure, so that the structure is more reliable and stable.

Referring to FIGS. 1-4, in the first embodiment, an upper trigger switch 31 and a lower trigger switch 32 are respectively provided on the left and right side of the rocker arm 4 and the two switches are arranged to be opposite to each other, the triggering directions of the two switches are parallel to the motor mounting base 3, the end of the cam 41 far away from the output shaft is arc-shaped, during swinging of the cam 41 in joint movement with the rocker arm 4, when the cam 41 rotates to a corresponding position of the upper trigger switch 31 or the lower trigger switch 32, the end of the cam 41 touches the metal shrapnel, and then the metal shrapnel is pressed to trigger the corresponding switch to control the motor 2 to stop running.

In the embodiment, limiting posts 33 for limiting the positions of shrapnels are respectively arranged on the motor mounting base 3 corresponding to the upper trigger switch 31 and the lower trigger switch 32, and the limiting posts 33 are arranged on the inner sides of the shrapnels, thus avoiding that the shrapnels may not reposition due to excessive distortion.

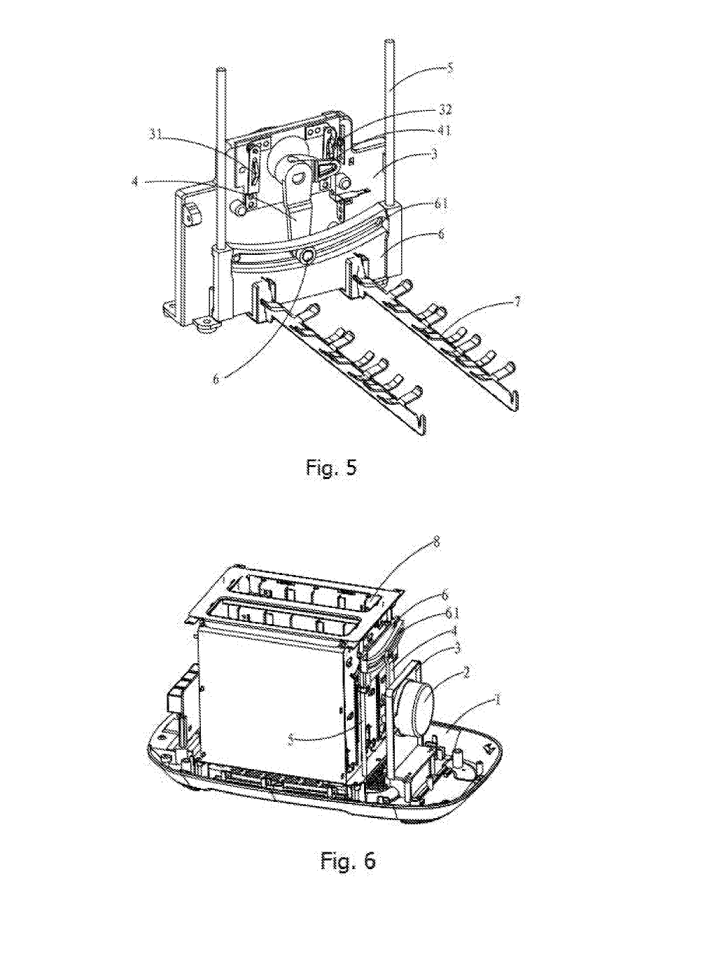

Referring to FIG. 5, in the second embodiment, an upper trigger switch 31 and a lower trigger switch 32 are respectively provided on the left and right side of the rocker arm 4, the two switches are fixed on the motor mounting base 3 in parallel and positioned in the rotation range of the cam 41, the triggering directions of the two switches are perpendicular to the motor mounting base 3. In this embodiment, the side edge of the cam 41 is provided with an arc-shaped edge so as to press the metal shrapnels of the switches. During swinging of the cam 41 in joint movement with the rocker arm 4, when the cam 41 rotates to the corresponding position of the upper trigger switch 31 or the lower trigger switch 32, the side edge of the cam 41 touches the metal shrapnel, and then the metal shrapnel is pressed to trigger the corresponding switch to control the motor 2 to stop running

Referring to FIG. 6, when in operation, when the motor 2 drives the bread carriers 7 to fall down to a set position, the lower trigger switch 32 is triggered by the cam 41 on the rocker arm 4 to stop the motor 2 from running, and the heating wire in the toaster is powered on for heating; after the bread is roasted for a preset time, the bread carriers 7 automatically rise up to their original height, the heating wire is controlled to stop working, and the upper trigger switch 31 is triggered by the cam 41 to stop the motor 2 from running at this moment, thus the degree of automation is high, the structure is useful and reliable, the operation is convenient, the control manner is easier to implement, and the production cost is lower.

The abovementioned contents are only preferred embodiments of the utility model, and the utility model is not limited thereto. Embodiments should all fall within the protection scope of the invention as long as they achieve the technical effects of the utility model by the equivalent means.

1. An automatic lifting device for a toaster carrier, comprising a machine base, carriers, sliding guide pillars, a slide seat, a rocker arm, a motor and a motor mounting base, wherein the sliding guide pillars being perpendicularly fixed on the machine base, the slide seat being slidably connected to the sliding guide pillars, the carriers being connected to the slide seat, the motor being fixed on the motor mounting base, and the output rotation shaft of the motor being connected with the slide seat via the rocker arm, characterized in that a cam is arranged on the rocker arm, the motor mounting base is provided with an upper trigger switch and a lower trigger switch corresponding to the swinging positions of the cam, and both the upper trigger switch and the lower trigger switch are shrapnel-type trigger switches.

2. The automatic lifting device for the toaster carrier according to claim 1, characterized in that a guide slot is arranged on the slide seat, and a bearing is arranged in the guide slot and connected with the rocker arm by a shaft.

3. The automatic lifting device for the toaster carrier according to claim 2, characterized in that the guide slot an arc-shaped slot.

4. The automatic lifting device for the toaster carrier according to claim 1, characterized in that the cam and the rocker arm are coaxially connected with an output rotation shaft of the motor, and the cam is arranged on one side of the output shaft of the motor close to the motor.

5. The automatic lifting device of the toaster carriers according to any one of claim 1, characterized in that the rocker arm and the cam are an integrally formed L-shaped crank structure.

6. The automatic lifting device for the toaster carrier according to claim 5, characterized in that the upper trigger switch and the lower trigger switch are respectively provided on the left and right side of the rocker arm and arranged to be corresponding to each other, and when the rocker arm swings in linkage with the cam, one end of the cam away from the output shaft triggers the upper trigger switch and the lower trigger switches.

7. The automatic lifting device for the toaster carrier according to claim 6, characterized in that limiting posts for limiting positions of shrapnels are arranged on the motor mounting base respectively corresponding to the upper trigger switch and the lower trigger switch.

8. The automatic lifting device for the toaster carrier according to claim 5, characterized in that the upper trigger switch and the lower trigger switch are respectively provided on the left and right side of the rocker arm, and when the rocker arm swings in linkage with the cam, a side edge of the cam triggers the upper trigger switch and the lower trigger switch.
